(19) United States
(12) Patent Application Publication
(10) Pub. No.: US 2024/0020609 A1
(43) Pub. Date: Jan. 18, 2024

(54) SYSTEM AND METHOD TO FACILITATE AUTONOMOUS MACHINE RISK RELATIONSHIPS

(71) Applicants: David J. Turner, Farmington, CT (US); Joseph M. Samela, III, Bristol, CT (US)

(72) Inventors: David J. Turner, Farmington, CT (US); Joseph M. Samela, III, Bristol, CT (US)

(21) Appl. No.: 17/862,561

(22) Filed: Jul. 12, 2022

(51) Int. Cl. G06Q 10/06; G05B 19/418

(52) U.S. Cl. CPC G06Q 10/0635; G05B 19/41835; G05B 2219/31368

(57) ABSTRACT

A risk relationship data store contains electronic records that represent, for risk relationships with an enterprise: a risk relationship identifier, an autonomous machine identifier, at least one attribute value, and a resource amount. A device located proximate to an autonomous machine includes an interface for an entity associated with the autonomous machine and a transmitter to transmit a request signal generated via the interface. A back-end application computer server associates the request signal with a specific future operation of the autonomous machine and forwards information about the specific future operation to a remote risk relationship platform. The computer server then receives information about a potential risk relationship with another enterprise and transmits a risk relationship offer to the device located proximate to the autonomous machine. Responsive to an agreement signal received from the device located proximate to the autonomous machine, the risk relationship data store is updated.

### BACKGROUND

Machines, such as motor vehicles and the like, may operate autonomously. For example, a machine in an industrial manufacturing plant might produce products with no human intervention. In some cases, a machine is associated with a risk relationship with an enterprise, such as insurer. The level of risk associated with the machine may be based on, among other factors, details about the machine (e.g., hardware features and software versions), how the machine is utilized (e.g., how far or where a vehicle is driven). As such, a need exists to help establish and manage risk relationships for autonomous machines. Moreover, it may be desirable to provide systems and methods to perform these functions in a way that provides secure and efficient results.

### SUMMARY OF THE INVENTION

According to some embodiments, systems, methods, apparatus, computer program code and means are provided to help establish and manage risk relationships for autonomous machines.

A risk relationship data store contains electronic records that represent, for risk relationships with an enterprise: a risk relationship identifier, an autonomous machine identifier, at least one attribute value, and a resource amount. A device located proximate to an autonomous machine includes an interface for an entity associated with the autonomous machine and a transmitter to transmit a request signal generated via the interface. A back-end application computer server associates the request signal with a specific future operation of the autonomous machine and forwards information about the specific future operation to a remote risk relationship platform. The computer server then receives information about a potential risk relationship with another enterprise and transmits a risk relationship offer to the device located proximate to the autonomous machine. Responsive to an agreement signal received from the device located proximate to the autonomous machine, the risk relationship data store is updated.

Some embodiments comprise: means for receiving, by a transceiver remote from an autonomous machine, a request signal transmitted by a device located proximate to an autonomous machine and storing the signal in a memory unit, the transceiver including a back-end application computer server, wherein the device located proximate to an autonomous machine includes: (1) an interface for an entity associated with the autonomous machine, the entity comprising a party interested in a potential risk relationship in connection with the autonomous machine, and (2) a transmitter to transmit the request signal, generated via the interface, via a distributed communication network; means for associating, by a computer processor of the back-end application computer server, the request signal with a specific future operation of the autonomous machine; means for forwarding information about the specific future operation of the autonomous machine to a remote risk relationship platform; means for receiving, from the remote risk relationship platform, information about a potential risk relationship with another enterprise; means for transmitting at least one risk relationship offer, including information about the potential risk relationship with the other enterprise, to the device located proximate to the autonomous machine; and, responsive to an agreement signal received from the device located proximate to the autonomous machine, means for updating a risk relationship data store, wherein the risk relationship data store contains electronic records that represent, for each of a plurality of risk relationships with an enterprise: a risk relationship identifier, an autonomous machine identifier, at least one attribute value, and a resource amount.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to help establish and manage risk relationships for autonomous machines. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 shows an example system architecture that may be used according to some embodiments.

FIG. 2 is a high-level block diagram of a system in accordance with some embodiments.

FIG. 3 shows a method to monitor machine utilization according to some embodiments.

FIG. 4 is a self-driving vehicle trip-based insurance purchase flow in accordance with one embodiment.

FIG. 5 illustrates a smartphone self-driving vehicle trip-based insurance display according to some embodiments.

FIG. 6 is a high-level block diagram of a system in accordance with some embodiments.

FIG. 7 shows a method for self-driving vehicle trip-based insurance according to some embodiments.

FIG. 8 is system for a self-driving vehicle trip-based insurance marketplace in accordance with some embodiments.

FIG. 9 is a self-driving vehicle trip-based insurance tablet display in accordance with some embodiments.

FIG. 10 is a block diagram of an apparatus according to some embodiments of the present invention.

FIG. 11 is a portion of a risk relationship database in accordance with some embodiments.

FIG. 12 illustrates a system associated with a predictive model according to some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access, and/or accuracy of communications between devices by implementing a specific new method and system as defined herein. The present invention is a specific advancement in the area of machine monitoring, risk sharing, and/or analysis by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, updated, and analyzed via a back-end-end application server to accurately improve machine learning algorithms and the exchange of information, thus improving the overall efficiency of the system associated with message storage requirements and/or bandwidth considerations (e.g., by reducing the number of messages that need to be transmitted via a network). Moreover, embodiments associated with collecting accurate information might further improve risk values, predictions of risk values, allocations of resources, risk relationship decisions, etc.

A system and method configured to help establish and manage risk relationships for autonomous machines is described. The description may, in some embodiments, include a plurality of sensors located proximate to the vehicle, each sensor configured to monitor at least one vehicle parameter, the plurality of sensors selected from an accelerometer, speed, temperature, mileage, oil level, oil pressure, run-time and location sensors, each sensor generating a signal encapsulating the monitored vehicle parameter and transmitting the generated signal to a control unit. Some embodiments include a control unit that receives the generated signal from each of a plurality of sensors, the control unit including a memory that stores the received signal and selectively combines the received signal with other signals received from others of the plurality of sensors. The description includes a first transmitter coupled to the control unit capable of transmitting the combined signal. Some embodiments include a second transceiver remote from the vehicle that receives a transmitted condition, compares that condition to received conditions from other vehicles and provides feedback to adjust the use of the vehicle based on the comparison, and a user interface for providing feedback to a user including at least one of visual indication, audible indication, and physically altering the use of the vehicle. Some embodiments include coupling the plurality of sensors to the control unit with a Controller Area Network (“CAN”) bus protocol. The first transmitter may transmit over a Radio Frequency (“RF”) network.

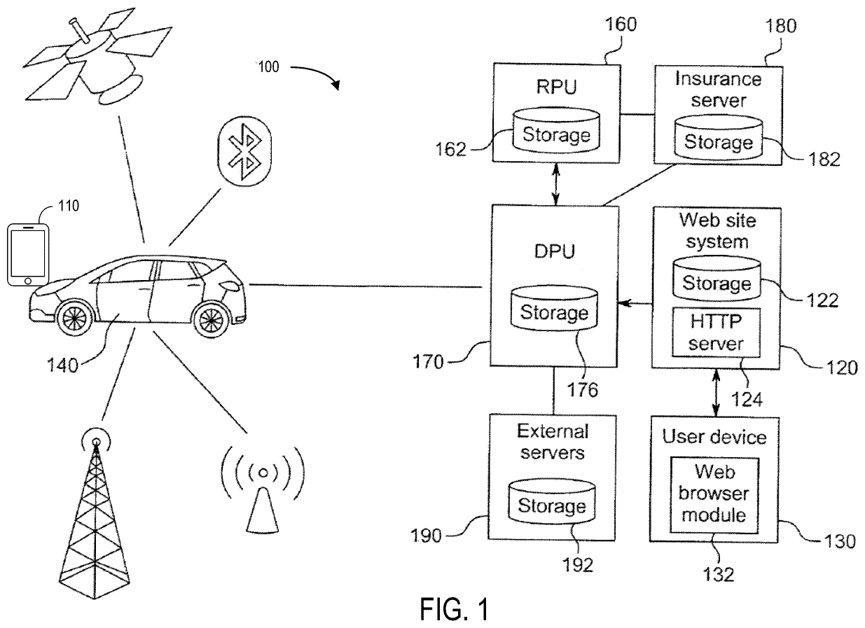

FIG. 1 shows an example system 100 that may be used according to some embodiments. The example system 100 includes an autonomous vehicle 140 having passenger with a smartphone 110 or another device. In some embodiments, the smartphone 110 executes a telematics application such as a TrueLane® application. The telematics devices may further include On-Board Diagnostic (“OBD”) devices, tablets, laptops, OEM connectivity devices, and/or similar devices. The vehicle 140 may be in communication with multiple devices over different networks, including a satellite, a cellular station, a Wi-Fi hotspot, BLUETOOTH® devices, and/or the smartphone 110 (which might instead communicate directly with cellular stations and/or Wi-Fi hotspots and not the vehicle 140). The smartphone 110 may be operated by a third-party vendor that collects telematics data. The smartphone 110 may include storage. The smartphone 110 may sense and collect the telematics data and then transmit the telematics data to a Data Processing Unit (“DPU”) 170. The telematics data may be communicated to the DPU 170 in any number of formats. The telematics data may be transmitted as raw data, it may be transmitted as summary data, or it may be transmitted in a format requested by the DPU 170. For example, the DPU 170 may transmit a customized summary of the telematics data to the DPU 170, in a format usable by the DPU 170. The DPU 170 may also be configured to communicate with a Risk and Pricing Unit (“RPU”) 160 including storage 162, insurance servers 180, including storage 182, and external servers 190 (e.g., social media networks, official/government networks), which are all connected by one or more networks.

The one or more telematics devices associated with the vehicle 140 may communicate with a satellite, Wi-Fi hotspot, BLUETOOTH® devices and even other vehicles. In some embodiments, the telematics devices associated with the vehicle 140 report this information to the smartphone 110 which may also directly detect telematics data. As will be described in greater detail hereafter, the smartphone 110 or other vehicle device may exchange data with the DPU 170 which may be configured to consolidate biographic and telematics data to monitor the use of the vehicle 140.

The web site system 120 provides a web site that may be accessed by a user device 130. The web site system 120 includes a Hypertext Transfer Protocol (“HTTP”) server module 124 and a database 122. The HTTP server module 124 may implement the HTTP protocol and may communicate Hypertext Markup Language (“HTML”) pages and related data from the web site to/from the user device 130 using HTTP. The web site system 120 may be connected to one or more private or public networks (such as the Internet), via which the web site system 120 communicates with devices such as the user device 130. The web site system 120 may generate one or more web pages that provide communication setting information, may communicate the web pages to the user device 130, and may receive responsive information from the user device 130.

The HTTP server module 124 in the web site system 120 may be, for example, an APACHE® HTTP server, a SUN-ONE® Web Server, a MICROSOFT® Internet Information Services (“ITS”) server, and/or may be based on any other appropriate HTTP server technology. The web site system 120 may also include one or more additional components or modules (not depicted), such as one or more load balancers, firewall devices, routers, switches, and devices that handle power backup and data redundancy.

The user device 130 may be, for example, a cellular phone (including the smartphone 110), a desktop computer, a laptop computer, a tablet computer, or any other appropriate computing device. The user device 130 may further be configured to operate as a telematics device. The user device 130 includes a web browser module 132, which may communicate data related to the web site to/from the HTTP server module 124 in the web site system 120. The web browser module 132 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 132 may implement Rich Internet Application (“MA”) and/or multimedia technologies such as ADOBE® FLASH, MICROSOFT® SILVERLIGHT, and/or other technologies. The web browser module 132 may implement MA and/or multimedia technologies using one or more web browser plug-in modules (such as, for example, an ADOBE® FLASH or MICROSOFT® SILVERLIGHT plug-in), and/or using one or more sub-modules within the web browser module 132 itself. The web browser module 132 may display data on one or more display devices (not depicted) that are included in or connected to the user device 130, such as a Liquid Crystal Display (“LCD”) or monitor. The user device 130 may receive input from the user of the user device 130 from input devices (not depicted) that are included in or connected to the user device 130, such as a keyboard, a mouse, or a touch screen, and provide data that indicates the input to the web browser module 132.

The example system 100 of FIG. 1 may also include one or more wired and/or wireless networks (not depicted), via which communications between the elements in the example system 100 may take place. The networks may be private or public networks, and/or may include the Internet.

Each or any combination of the modules shown in FIG. 1 may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition, or as an alternative to the features of these modules described above with reference to FIG. 1, these modules may perform any of the functionality described herein.

The smartphone 110 or other vehicle device may include one or more sensors, such as an accelerometer, speed and location sensors, for example. By way of non-limiting example only, these sensors may include temperature as well as systems that provide other types of vehicle data. Other types of sensors including impact sensors, chemical sensors and pressure sensors may be utilized in the present system.

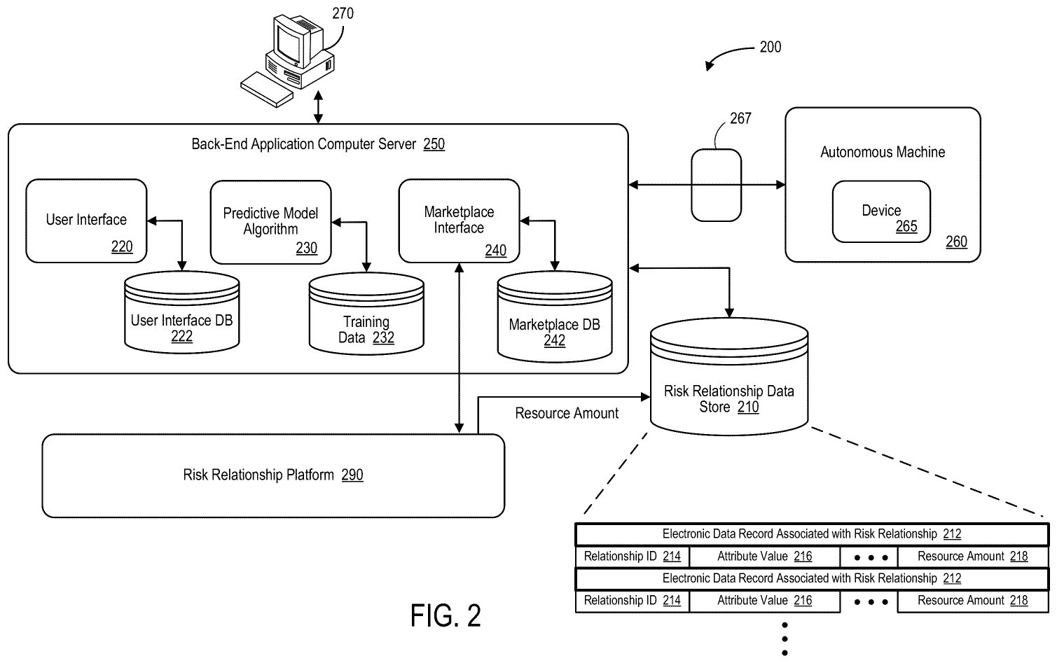

FIG. 2 is a high-level block diagram of a system 200 according to some embodiments of the present invention. In particular, the system 200 includes a back-end application computer server 250 that may access information in a risk relationship data store 210 (e.g., storing a set of electronic records 212 representing risk associations, each record including, for example, one or more risk relationship identifiers 214, attribute values 216 such as an autonomous machine identifier, resource amounts 218, etc.). The back-end application computer server 250 may also retrieve information from other data stores or sources in connection with a risk relationship algorithm (e.g., trained via machine learning) to update the electronic records based on a likely operation of the machine. The back-end application computer server 250 may also exchange information with a remote autonomous machine 260 or a device 265 co-located with the machine 260 (e.g., via a firewall 267). According to some embodiments, an interactive graphical user interface platform of the back-end application computer server 250 (and, in some cases, third-party data) may facilitate forecasts, decisions, predictions, and/or the display of offers or results via one or more remote administrator computers 270 (e.g., to gather additional information about an existing association) and/or the remote autonomous machine 260. Note that the back-end application computer server 250 and/or any of the other devices and methods described herein might be associated with a third-party, such as a vendor that performs a service for an enterprise.

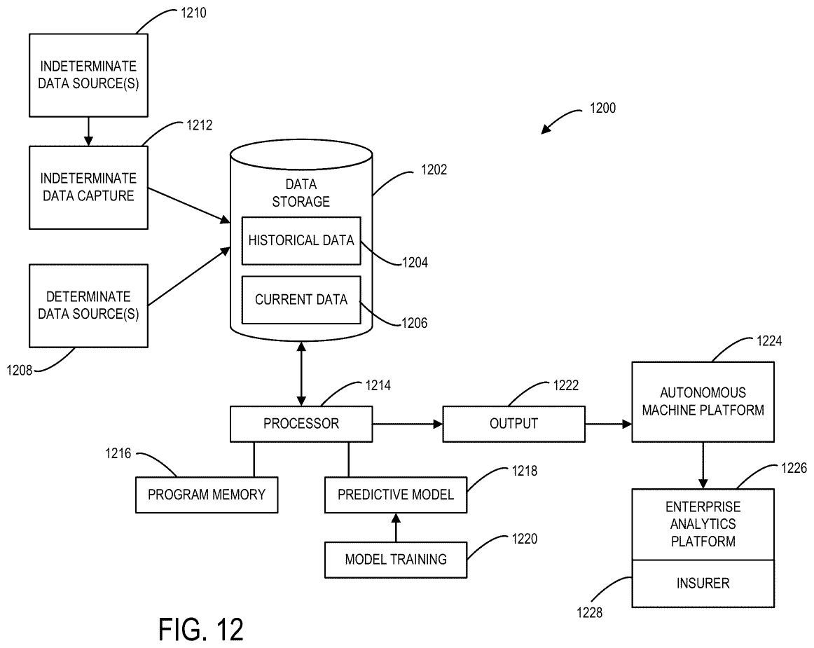

According to some embodiments, the back-end application computer server 250 includes a user interface 220 and a user interface database 222. The user interface 220 may exchange information with the autonomous machine 260 or device 265 to establish or manage risk relationship. In addition, the back-end application computer server 250 may include a predictive model algorithm 230 and training data 232. The predictive model algorithm 230 may help facilitate the establishment and management of risk relationships (e.g., by helping calculate a resource amount). Similarly, the back-end application computer server 250 may include a marketplace interface 240 and a marketplace database 242. The marketplace interface 240 may exchange information with a risk management platform 290 in connection with potential risk relationships with an enterprise and/or other enterprises. The risk management platform 290 may then use information from the back-end application computer server 250, along with a level of utilization of the machine 260, to generate an updated resource amount 218 (e.g., using a predictive model as described with respect to FIG. 12).

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate updates of electronic records in the risk relationship data store 210. As used herein, the term “automated” may refer to, for example, actions that can be performed with little (or no) intervention by a human.

As used herein, devices, including those associated with the back-end application computer server 250 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the risk relationship data store 210. The risk relationship data store 210 might, for example, store electronic records 212 representing a plurality of existing risk associations, each electronic record 212 having a set of attribute values 216 such as an autonomous machine identifier, and a resource amount 218. The risk relationship data store 210 may also contain information about prior and current interactions with parties, including those associated with autonomous devices 260. The risk relationship data store 210 may be locally stored or reside remote from the back-end application computer server 250. As will be described further below, the risk relationship data store 210 may be used by the back-end application computer server 250 in connection with the autonomous machine device 265 to improve the establishment and management of risk relationships. Although a single back-end application computer server 250 is shown in FIG. 2, any number of such devices may be included. Moreover, various devices described herein might be combined according to embodiments of the present invention. For example, in some embodiments, the back-end application computer server 250 and risk management platform 290 might be co-located and/or may comprise a single apparatus.

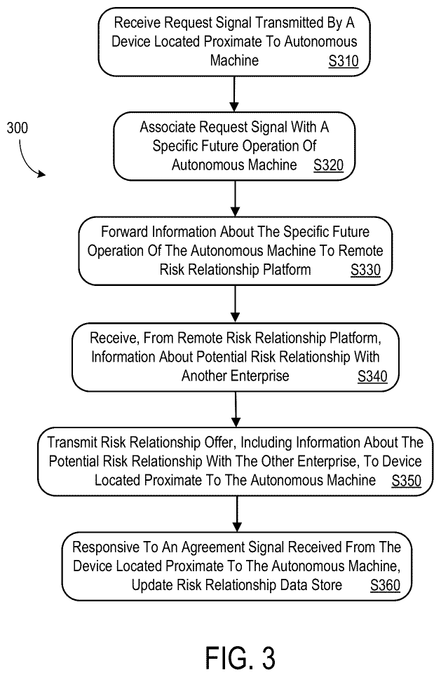

Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system described herein, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that, when executed by a machine, result in performance according to any of the embodiments described herein.

At S310, a transceiver remote from an autonomous machine receives a request signal transmitted by a device located proximate to an autonomous machine and stores the signal in a memory unit. The transceiver may, according to some embodiments, include a back-end application computer server. The device located proximate to the autonomous machine may include: (1) an interface for an entity associated with the autonomous machine (e.g., an owner or user of the machine or any other party interested in a potential risk relationship in connection with the machine), and (2) a transmitter to transmit the request signal, generated via the interface, via a distributed communication network.

At S320, a computer processor of the back-end application computer server may associate the request signal with a specific future operation of the autonomous machine. For example, the machine might be scheduled to run for the next twelve hours or to produce 5,000 units of a product. At S330, information about the specific future operation of the autonomous machine is forward to a remote risk relationship platform (e.g., digitally via an electronic message).

At S340, information about a potential risk relationship with another enterprise may be received from the remote risk relationship platform. At S350, the system may transmit at least one risk relationship offer, including information about the potential risk relationship with the other enterprise, to the device located proximate to the autonomous machine. Responsive to an agreement signal received from the device located proximate to the autonomous machine, at S360 the system may update a risk relationship data store, wherein the risk relationship data store contains electronic records that represent, for each of a plurality of risk relationships with an enterprise: a risk relationship identifier, an autonomous machine identifier, at least one attribute value, and a resource amount (e.g., an insurance premium amount.

Note that autonomous machines, including self-driving vehicles (e.g., automobiles, boats, drones, etc.), is an emerging market that presents the opportunity for a new type of insurance product designed specifically for the application of self-driving vehicles. Examples of such uses might include ride hailing or taxi services, commercial trucking, package delivery (to businesses or individuals), personal use, vehicle rentals, etc. Such a product may account for the unique usage and safety considerations of self-driving vehicles while remaining compatible with an owner's or passenger's business model. Some embodiments described herein provide a “trip-based” insurance product for self-driving vehicles that is purchased at the beginning of a trip, provides coverage(s) for the duration of the trip, and is rated using trip-data transmitted from the self-driving vehicle.

In some cases, self-driving vehicle manufacturers are positioning the technology for a pay-per-trip business model. Self-driving vehicles may be used by passengers that interact with the vehicle to select a well-defined destination and route. To fit into this business model, an insurance company may offer “per-trip” products that are consumable by the self-driving vehicle and rated on a per-trip basis. Trip-based insurance products use the destination, route, and any other trip data to rate the policy and calculate a premium quickly and accurately. As used herein, the phrase “trip-based” insurance may refer to a motor vehicle insurance policy that covers one individual trip—that is, the premium is calculated before policy is effective and the policy becomes effective at the start of a trip (expiring at the end). In contrast, a mileage-based insurance premium is calculated after policy expiration and is typically based only on a total number of miles that were driven.

Trip-based insurance for self-driving vehicles may provide cost savings to self-driving vehicle owners and passengers because they do not pay for insurance while the vehicle is parked. Additionally, the relatively short per-trip policy periods of trip-based insurance may increase consumer choice by enabling policy purchases from a different insurer every trip. Benefits for insurers may include: improved rating accuracy that uses trip data transmitted from the self-driving vehicle, and more opportunities to make rating model and variable adjustments due to short per-trip policy periods.

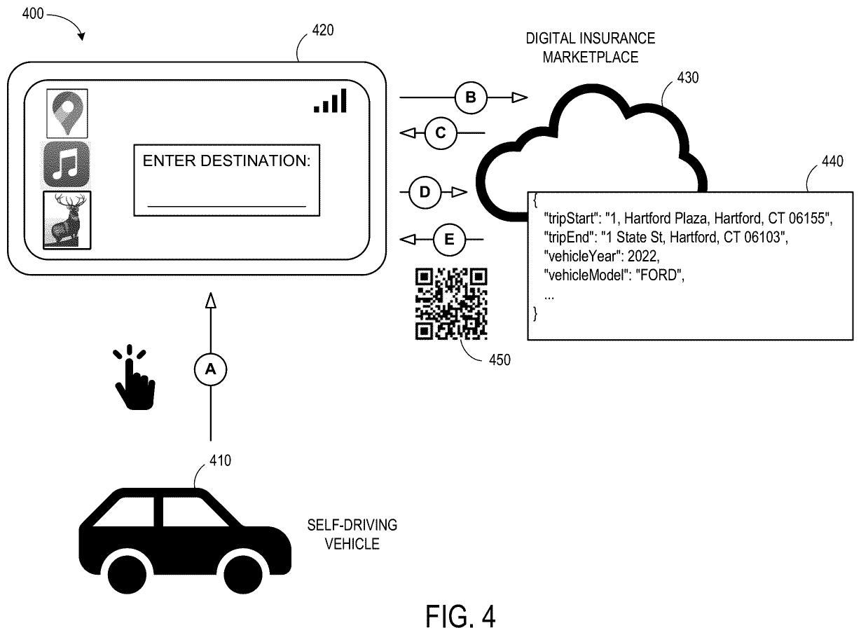

FIG. 4 is a self-driving vehicle trip-based insurance purchase flow 400 in accordance with one embodiment. At the start of a trip (A), a passenger enters a self-driving vehicle 410 and selects a target destination and route using an interface 420 built into the vehicle 410. The interface 420 might be associated with, for example, an Original Equipment Manufacturer (“OEM”) touchscreen, a navigation system, APPLE® CarPlay, ANDROID® Auto, etc. The self-driving vehicle 410 or interface 420 transmits the destination, route, and other trip information to a digital insurance marketplace 430 at (B). The insurance marketplace 430 is a digital storefront that contains a library of trip-based insurance products. Each insurance product uses the trip data transmitted from the self-driving vehicle 410 to calculate the rated-premium. Trip-based policies may be rated, for example, based on all available attributes of the trip. this data may include; start location, end location, distance, duration, route, time of day, weather conditions, traffic conditions, vehicle class, vehicle make/model/year, passenger profile, telematics information, etc. The insurance marketplace 430 uses the transmitted trip-data (e.g., represented by an electronic record 440) to calculate a premium for each trip-based insurance product and returns to the self-driving vehicle 410 or interface 420 a list of policy offers at (C). The passenger interacts with the interface 420 to select an insurance policy offer at (D) (or the vehicle 410 may select a policy offer on the passenger's behalf according to a previous configuration of preference information). Examples of automatic purchase preference configurations might include: lowest price, an amount of coverage, a preferred insurer, a loyalty program, rewards or promotional accounts, etc.

After the transaction is complete, the insurance marketplace 430 transmits to the self-driving vehicle 410 digital proof-of-insurance at (E) (e.g., a QR code 450). The digital proof-of-insurance describes the effective and expiration conditions of the policy. The digital proof-of-insurance may be interacted with via the vehicle interface 420, smartphone, or a digital wallet. Not that some jurisdictions may not require passengers to carry proof of insurance. For example, the Massachusetts Registry of Motor Vehicles (“RMV”) maintains a database of driver insurance policies. Massachusetts law enforcement does not require drivers to present proof of insurance, instead the information is accessed in a database using the vehicle license plate. In this case, at (E) the information might instead be transmitted along with the vehicle license plate to the database. Some embodiments may store information in a secure, distributed transaction ledger, such as one using blockchain technology. For example, if insurance products are sold as “smart-contracts” on a blockchain, then coverage can be confirmed immediately by introspection without a passenger holding proof of insurance.

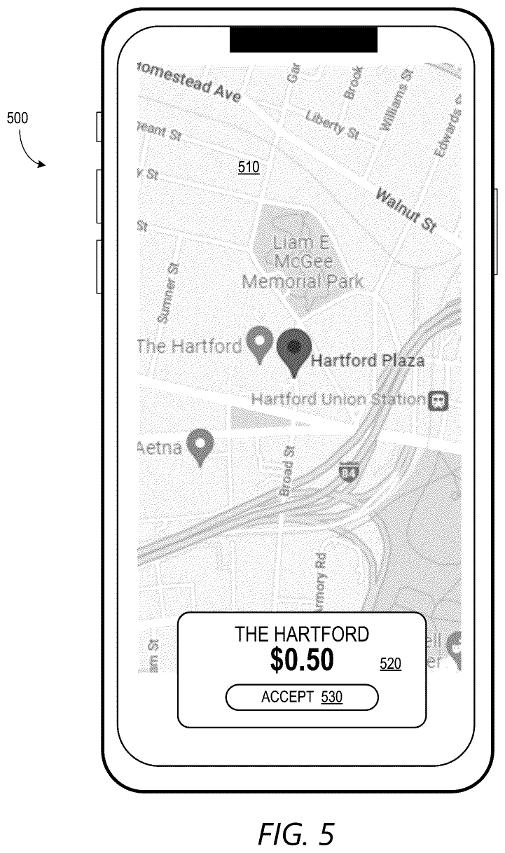

Instead of using the interface 420 built into the vehicle 410, some embodiments use a device co-located with the vehicle (e.g., a smartphone, tablet computer, smartwatch, etc.). For example, FIG. 5 illustrates a smartphone 500 self-driving vehicle trip-based insurance display 510 according to some embodiments. The display 510 includes a map that can be used to define an origin and/or destination location for a trip. An offer 520 from an insurance marketplace may then be provided on the display 510 and agreed to via an “Accept” icon 530.

In this way, embodiments may provide ways to purchase trip-based insurance for self-driving vehicles, ways to sell insurance, and/or ways to target insurance products (trip information might be used to target vehicles that are driving cross-country or to a particular region).

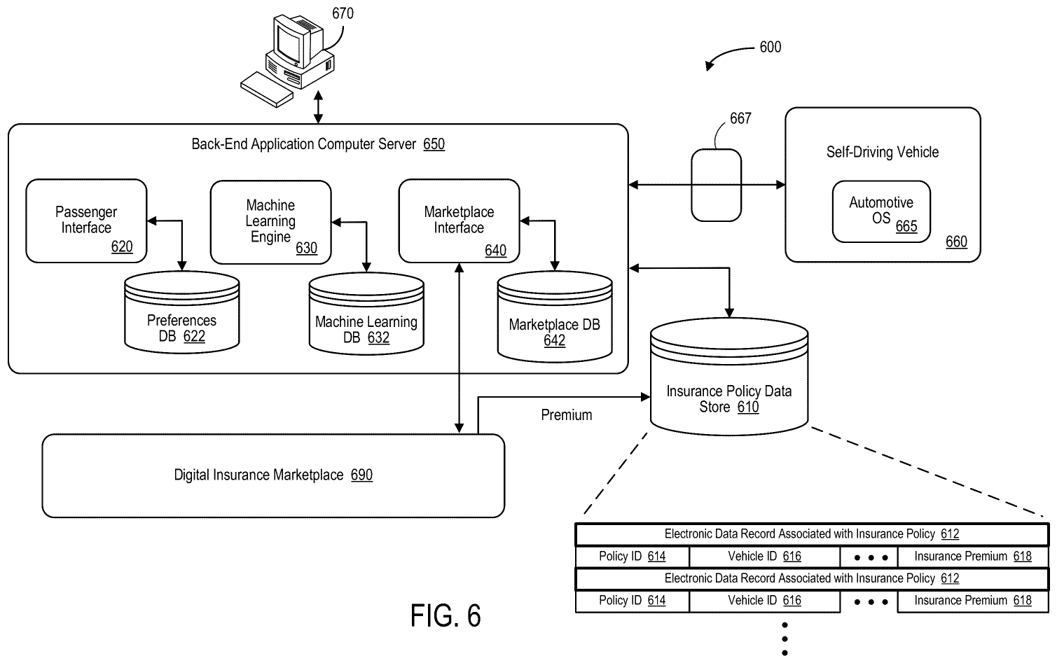

FIG. 6 is a high-level block diagram of a system 600 in accordance with some embodiments. As before, the system 600 includes a back-end application computer server 650 that may access information in an insurance policy data store 610 (e.g., storing a set of electronic records 612 representing insurance policies of an insurer, each record including, for example, one or more insurance policy identifiers 614, attribute variables (e.g., a self-driving vehicle identifier 616, a type of vehicle, a vehicle claim history, etc.), insurance premium values 618, etc. The back-end application computer server 650 may also exchange information with a remote self-driving vehicle 660 or automotive Operating System (“OS”) 665 associated with the vehicle 660 (e.g., via a firewall 667). According to some embodiments, an interactive graphical user interface platform of the back-end application computer server 650 (and, in some cases, third-party data) may facilitate forecasts, decisions, predictions, and/or the display of offers or results via one or more remote administrator computers 670 (e.g., to gather additional information about an existing insurance policy) and/or the remote vehicle 660. Note that the back-end application computer server 650 and/or any of the other devices and methods described herein might be associated with a third-party, such as a vendor that performs a service for an enterprise.

According to some embodiments, the back-end application computer server 650 includes a passenger interface 620 and a preferences database 622. The passenger interface 620 may be used to define rules in connection with the automatic acceptance of trip-based insurance offers (e.g., always accept the policy with the lowest premium). In addition, the back-end application computer server 650 may include a machine learning engine 630 and a machine learning database 632. The machine learning engine 630 may use information in the machine learning database 632 to establish an automatic estimate of an insurance premium for a particular trip. Similarly, the back-end application computer server 650 may include a marketplace interface 640 and marketplace database 642. The marketplace interface 640 may exchange information with a digital insurance marketplace 690 to receive information about trip-based insurance offers from other insurers. An updated insurance premium 618 may then be stored in the insurance policy data store 610.

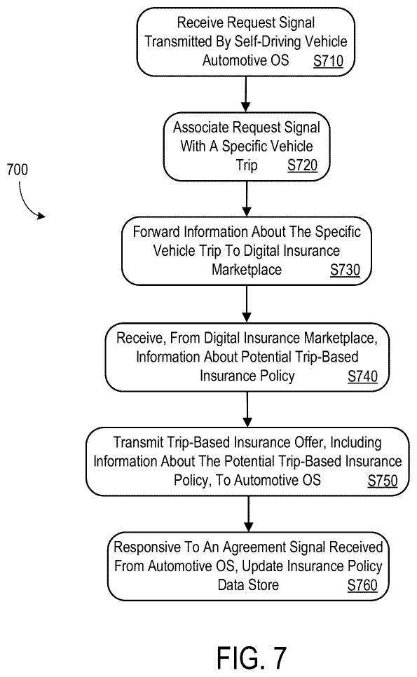

FIG. 7 shows a method 700 for self-driving vehicle trip-based insurance according to some embodiments. At S710, a request signal generated by a self-driving vehicle automotive OS may be received. At S720, the received request signal is associated with a specific vehicle trip (e.g., from an origin location to a destination location). At S730, information about the specific vehicle trip to forwarded to a digital insurance marketplace (e.g., maintained by an insurer). The trip information forwarded to the remote risk relationship platform might include, for example, a time of day, a location, a type of road (e.g., highway or side street), weather information, an amount of traffic, a distance to another vehicle, operation of other machines in similar conditions, a risk hotspot (e.g., a construction zone), a distance to an intersection, etc. Other examples of trip data include information about the vehicle, including anti-lock brakes, adaptive headlights, a camera, a parking feature, etc. Still other examples of trip data include a vehicle class, a trip type, a vehicle make, model, and year of production, a passenger profile, third-party information, motor vehicle registration information, prior safety scoring (e.g., for a particular self-driving software version or patch), a predictive algorithm, etc.

At S740, information about a potential trip-based insurance policy is received from the digital insurance marketplace (e.g., in connection with another insurer). At S750, a trip-based insurance offer is transmitted to the automotive OS. Responsive to an agreement signal received via the automotive OS, an insurance policy data store may be updated at S760 (e.g., with an agreed upon insurance premium for the trip-based automobile insurance policy). In some embodiments, the agreement signal received from the device located proximate to the self-driving vehicle is automatically generated based on a passenger preference (e.g., based an insurance premium, a preferred insurer, an amount of coverage, etc.). Note that the trip-based automobile insurance policy might be associated with a potential automobile insurance policy, a newly issued automobile insurance policy, an automobile insurance policy renewal (e.g., for a subsequent trip), etc.

According to some embodiments, an enterprise platform (e.g., associated with an insurer) may also interface with servers, cloud resources, and insurance applications, such as a claims engine, a reporting engine, a rating engine, a digital negotiation engine, etc. In this way, the platform may provide versatility by removing dependence on a specific source of trip-based data without refiling. Moreover, the platform may improve speed-to-market because software can be developed once and used many times allowing for faster development of new capabilities. In addition, the platform may provide insights and attributes by leveraging a common set of internal models and insights. Finally, the platform may facilitate operational scale by using trip-based data throughout the organization (that is, beyond insurance premium pricing).

In some embodiments described herein, a single passenger may purchase trip-based insurance for a self-driving vehicle from a single insurer. Embodiments, however, can apply to any other of a number of situations. For example, a group of passengers in the vehicle may share the insurance cost. Moreover, a single trip might by covered by multiple insurers (e.g., one insurer for a New Jersey portion of a trip, another one for New York, and still another one for Canada). As another example, the cost of insurance for a single trip might be shared by a vehicle owner, one or more passengers, a service provider (e.g., UBER®), an employer of a passenger, a local government, etc.

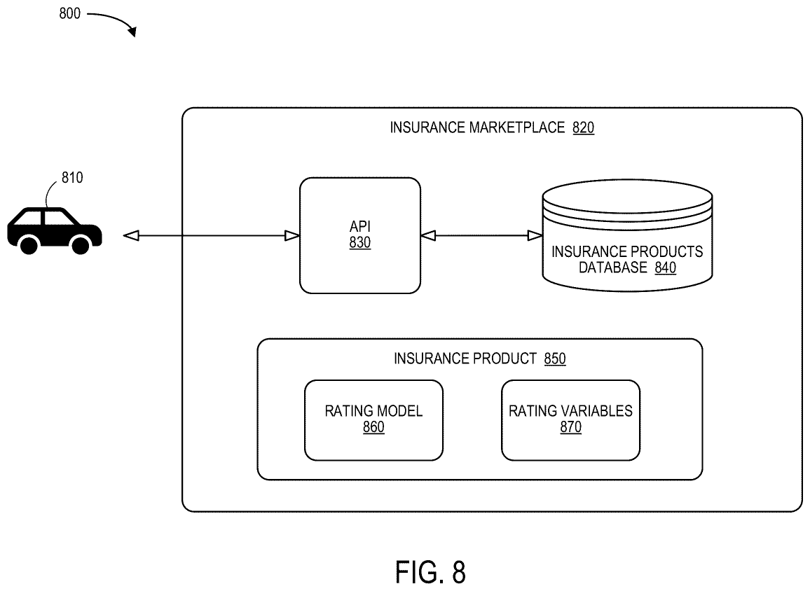

FIG. 8 is a system 800 for a self-driving vehicle trip-based insurance marketplace 820 in accordance with some embodiments. The communication between a self-driving vehicle 810 and the insurance marketplace 820 is a digital process that occurs over the Internet. To communicate over the Internet, the self-driving vehicle 810 may be equipped with cellular, Wi-Fi, Bluetooth or other wireless data connection. The self-driving vehicle 810 may exchange information with the insurance marketplace 820 over the internet using HTTP or another network protocol. The insurance marketplace 820 is comprised of two primary software programs:
An API 830 which is a software program that handles communication between the self-driving vehicle and insurance marketplace
An insurance products database 840 that contains all trip-based insurance products available for purchase. Each insurance product 850 is comprised of a rating model 860 and definitions for each required or optional rating variables 870.

The insurance product 850 might, for example, define an insurance premium as follows:

$$Premium = miles \times \frac{\$ 0.02}{mile} + weatherSeverity \times \frac{\$ 0.001}{point} + ModelAge \times \frac{\$ 0.0005}{year}$$

Note that this equation is provided only as an example, and embodiments might utilize any other types of equations (including, for example, other trip attributes, other pricing values, other weights, machine learning algorithms, etc.). Moreover, different insurers might utilize different equations (and compete to provide insurance products based on the accuracy of their risk allocation predictions).

Upon receiving a request for trip-based insurance from the self-driving vehicle 810, the insurance marketplace 820 API 830 will input the transmitted trip-data into the rating model 860 of each insurance product 850 and record the calculated premium. The API 830 will transmit the calculated premium of each product back to the self-driving vehicle 810 with additional information about each product (e.g., insurance provider name, policy qualification, reward points, etc.). After the passenger selects the insurance offer and completes the transaction, the API 830 will register the policy as active and transmit to the self-driving vehicle 810 digital proof-of-insurance.

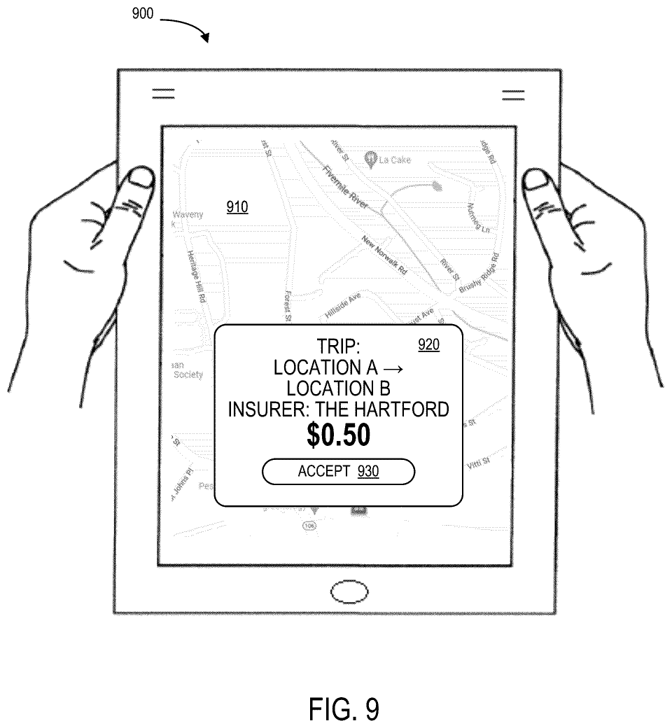

FIG. 9 is a self-driving vehicle trip-based insurance tablet 900 display 910 in accordance with some embodiments. The display 910 includes a map that can be used to define a trip and insurance offer details 920 that can be agreed to using an “Accept” icon 930 (e.g., via a touchscreen).

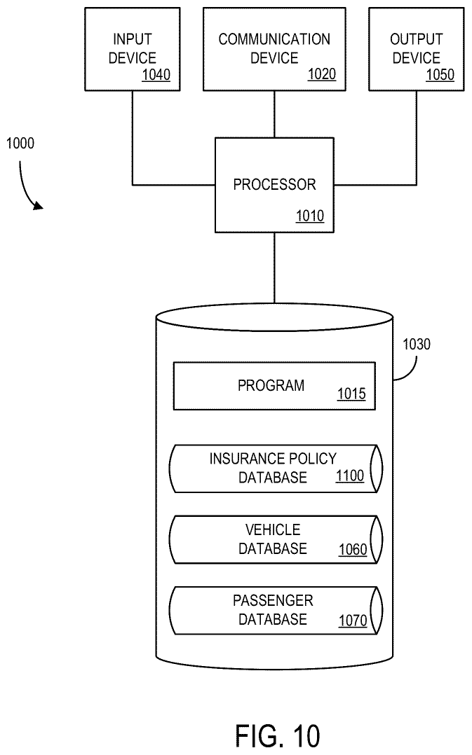

The embodiments described herein may be implemented using any number of different hardware configurations. For example, FIG. 10 illustrates an apparatus 1000 that may be, for example, associated with system that facilitate risk relationships associated with an autonomous machine. The apparatus 1000 comprises a processor 1010, such as one or more commercially available Central Processing Units (“CPUs”) in the form of one-chip microprocessors, coupled to a communication device 1020 configured to communicate via a communication network (not shown in FIG. 10). The communication device 1020 may be used to communicate, for example, with one or more remote administrator computers, OEM devices, and or communication devices (e.g., smartphones). Note that communications exchanged via the communication device 1020 may utilize security features, such as those between a public internet user and an internal network of the insurance enterprise. The security features might be associated with, for example, web servers, firewalls, and/or PCI infrastructure. The apparatus 1000 further includes an input device 1040 (e.g., a mouse and/or keyboard to enter information about electronic wallet thresholds, machine learning algorithms, predictive analytics, etc.) and an output device 1050 (e.g., to output reports regarding insurance premium offers, premiums, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1015 and/or a trip-based insurance tool or application for controlling the processor 1010. The processor 1010 performs instructions of the program 1015, and thereby operates in accordance with any of the embodiments described herein. For example, the processor 1010 may associate a request signal with a specific future operation of an autonomous machine and forward information about the specific future operation to a remote risk relationship platform. The processor 1010 may then receive information about a potential risk relationship (e.g., with another enterprise) and transmits a risk relationship offer to the device located proximate to the autonomous machine. Responsive to an agreement signal received from the device located proximate to the autonomous machine, a risk relationship data store may be updated by the processor 1010.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the apparatus 1000 from another device; or (ii) a software application or module within the apparatus 1000 from another software application, module, or any other source.

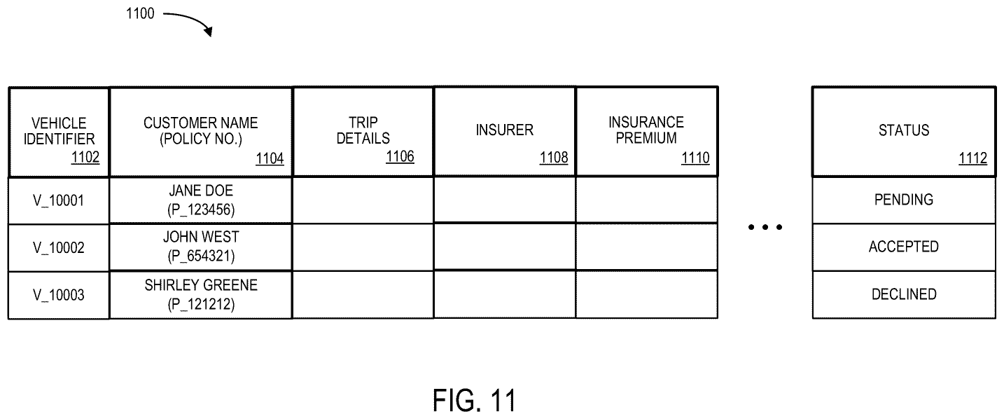

In some embodiments (such as shown in FIG. 10), the storage device 1030 further stores an insurance policy database 1100, a vehicle database 1060, and a passenger database 1070. Examples of a database that might be used in connection with the apparatus 1000 will now be described in detail with respect to FIG. 11. Note that the database described herein is only an example, and additional and/or different information may be stored therein. Moreover, various databases might be split or combined in accordance with any of the embodiments described herein. For example, the vehicle database 1060 and the passenger database 1070 might be combined and/or linked to each other within the program 1015.

Referring to FIG. 11, a table is shown that represents the insurance policy database 1100 that may be stored at the apparatus 1000 according to some embodiments. The table may include, for example, entries associated with automobile insurance policies. The table may also define fields 1102, 1104, 1106, 1108, 1110, 1112 for each of the entries. The fields 1102, 1104, 1106, 1108, 1110, 1112 may, according to some embodiments, specify: a vehicle identifier 1102, a customer name and policy number 1104, trip details 1106, an insurer 1108, an insurance premium amount 1110, and status 1112. The insurance policy database 1100 may be created and updated, for example, based on information electrically received from various computer systems, including those associated with a self-driving vehicle, an insurance provider, and a digital marketplace.

The vehicle identifier 1102 may be, for example, a unique alphanumeric code identifying a vehicle (e.g., a self-driving automobile to be insured). The customer name and policy number 1104 may identify, for example, an owner of the vehicle and insurance policy number. The trip details 1106 might include a time-of-day, origin and destination locations, route data, etc. The insurer 1108 might define who is providing a trip-based insurance offer). The insurance premium amount 1110 might represent an amount that will be charged per mile driven or per overall trip. The status 1112 might indicate that a trip-based insurance offer is pending, has been accepted, has been declined, etc.

According to some embodiments, one or more predictive models may be used to generate insurance premium models, help underwrite insurance policies, and/or predict potential risk based on prior events and claims. Features of some embodiments associated with a predictive model will now be described by referring to FIG. 12. FIG. 12 is a partially functional block diagram that illustrates aspects of a computer system 1200 provided in accordance with some embodiments of the invention. For present purposes, it will be assumed that the computer system 1200 is operated by an insurance company (not separately shown) to support telematics data monitoring and processing.

The computer system 1200 includes a data storage module 1202. In terms of its hardware the data storage module 1202 may be conventional, and may be composed, for example, of one or more magnetic hard disk drives. A function performed by the data storage module 1202 in the computer system 1200 is to receive, store and provide access to both historical claim transaction data (reference numeral 1204) and current claim transaction data (reference numeral 1206). As described in more detail below, the historical claim transaction data 1204 is employed to train a predictive model to provide an output that indicates potential damage patterns, and the current claim transaction data 1206 is thereafter analyzed by the predictive model. Moreover, as time goes by, and results become known from processing current claim transactions, at least some of the current claim transactions may be used to perform further training of the predictive model. Consequently, the predictive model may thereby adapt itself to changing event impacts and updated telematics or trip-based data (e.g., a new variable being monitored).

Either the historical claim transaction data 1204 or the current claim transaction data 1206 might include, according to some embodiments, determinate and indeterminate data. As used herein and in the appended claims, “determinate data” refers to verifiable facts such as the age of a vehicle; a vehicle type; an event type (e.g., an accident or breakdown); a date of loss, or date of report of claim, or policy date or other date; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files. Indeterminate data extracted from medical notes or accident reports might be associated with, for example, an amount of loss and/or details about damages.

The determinate data may come from one or more determinate data sources 1208 that are included in the computer system 1200 and are coupled to the data storage module 1202. The determinate data may include “hard” data like a claimant's name, tax identifier umber, policy number, address; the date of loss; the date the claim was reported, etc. One possible source of the determinate data may be the insurance company's policy database (not separately indicated). Another possible source of determinate data may be from data entry by the insurance company's claims intake administrative personnel.

The indeterminate data may originate from one or more indeterminate data sources 1210 and may be extracted from raw files or the like by one or more indeterminate data capture modules 1212. Both the indeterminate data source(s) 1210 and the indeterminate data capture module(s) 1212 may be included in the computer system 1200 and coupled directly or indirectly to the data storage module 1202. Examples of the indeterminate data source(s) 1210 may include data storage facilities for document images, for text files (e.g., claim handler notes), digitized recorded voice files (e.g., claimant oral statements, witness interviews, claim handler oral notes, etc.), streams of video information, etc. Examples of the indeterminate data capture module(s) 1212 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual. For example, claim handlers' opinions may be extracted from their narrative text file notes.

The computer system 1200 also may include a computer processor 1214. The computer processor 1214 may include one or more conventional microprocessors and may operate to execute programmed instructions to provide functionality as described herein. Among other functions, the computer processor 1214 may store and retrieve historical claim transaction data 1204 and current claim transaction data 1206 in and from the data storage module 1202. Thus, the computer processor 1214 may be coupled to the data storage module 1202.

The computer system 1200 may further include a program memory 1216 that is coupled to the computer processor 1214. The program memory 1216 may include one or more fixed storage devices, such as one or more hard disk drives, and one or more volatile storage devices, such as RAM devices. The program memory 1216 may be at least partially integrated with the data storage module 1202. The program memory 1216 may store one or more application programs, an operating system, device drivers, etc., all of which may contain program instruction steps for execution by the computer processor 1214.

The computer system 1200 further includes a predictive model component 1218. In certain practical embodiments of the computer system 1200, the predictive model component 1218 may effectively be implemented via the computer processor 1214, one or more application programs stored in the program memory 1216, and data stored as a result of training operations based on the historical claim transaction data 1204 (and possibly also data received from a third-party reporting service). In some embodiments, data arising from model training may be stored in the data storage module 1202, or in a separate data store (not separately shown). A function of the predictive model component 1218 may be to determine appropriate simulation models, results, and/or scores (e.g., a rating indicating how risky a road is as compared to similar roads). The predictive model component 1218 may be directly or indirectly coupled to the data storage module 1202.

The predictive model component 1218 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1200 includes a model training component 1220. The model training component 1220 may be coupled to the computer processor 1214 (directly or indirectly) and may have the function of training the predictive model component 1218 based on the historical claim transaction data 1204 and/or information about telematics, incidents, and alerts. (As will be understood from previous discussion, the model training component 1220 may further train the predictive model component 1218 as further relevant data becomes available.) The model training component 1220 may be embodied at least in part by the computer processor 1214 and one or more application programs stored in the program memory 1216. Thus, the training of the predictive model component 1218 by the model training component 1220 may occur in accordance with program instructions stored in the program memory 1216 and executed by the computer processor 1214.

In addition, the computer system 1200 may include an output device 1222. The output device 1222 may be coupled to the computer processor 1214. A function of the output device 1222 may be to provide an output that is indicative of (as determined by the trained predictive model component 1218) particular risk maps, events, insurance underwriting parameters, and recommendations. The output may be generated by the computer processor 1214 in accordance with program instructions stored in the program memory 1216 and executed by the computer processor 1214. More specifically, the output may be generated by the computer processor 1214 in response to applying the data for the current simulation to the trained predictive model component 1218. The output may, for example, be a monetary estimate, damage risk level, and/or likelihood within a predetermined range of numbers. In some embodiments, the output device may be implemented by a suitable program or program module executed by the computer processor 1214 in response to utilization of the predictive model component 1218.

Still further, the computer system 1200 may include an autonomous machine platform 1224. The autonomous machine platform 1224 may be implemented in some embodiments by a software module executed by the computer processor 1214. The autonomous machine platform 1224 may have the function of rendering a portion of the display on the output device 1222. Thus, the autonomous machine platform 1224 may be coupled, at least functionally, to the output device 1222. In some embodiments, for example, the autonomous machine platform 1224 may direct workflow by referring, to an enterprise analytics platform 1226, telematics recommendations, modification recommendations, underwriting parameters, and/or trip-based insurance offers generated by the predictive model component 1218 and found to be associated with various trip details. In some embodiments, this data may be provided to an insurer 1228 who may modify insurance parameters (e.g., insurance premiums) as appropriate.

Thus, embodiments may provide an automated and efficient way to facilitate the establishment and management of risk relationships for autonomous machines in a way that provides secure and efficient results. Moreover, embodiments may revolutionize auto insurance by creating an ongoing relationship with the consumer that offers them greater control and transparency. Some embodiments are consumer focused and can create products that are valuable, simple, and engaging to the consumer. Moreover, embodiments may be adaptable and adjust insurance pricing and discounts as trip information changes over time. Embodiments may be resilient and help ensure that product offerings are not dependent on a specific vendor or source of trip data. Further, embodiments may be connected and designed with speed of change and evolution of use in mind.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., boat insurance policies, motorcycle insurance policies, etc.). Similarly, although certain attributes were described in connection some embodiments herein, other types of attributes might be used instead.

According to some embodiments a risk score and/or trip data might be made available to another insurance company in connection with a future automobile insurance policy associated with the passenger or vehicle. For example, a risk score might travel with an insured or vehicle when they switch insurance companies (e.g., like a credit score might follow a person). A risk score might, in some embodiments, be associated with lead generation (e.g., to target safer routes with insurance offers) and/or gamified digital engagement to improve trip selection.

According to some embodiments, a risk score may be used to facilitate an incremental insurance policy. For example, an incremental insurance policy might be a “pay-per-mile” policy for infrequent drivers based on a number of miles traveled. Similarly, an incremental insurance policy might instead be based on an amount of time spent traveled (e.g., “pay-per-hour” insurance).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A system to facilitate risk relationships for autonomous machines, comprising:
a risk relationship data store containing electronic records that represent, for each of a plurality of risk relationships with an enterprise: a risk relationship identifier, an autonomous machine identifier, at least one attribute value, and a resource amount;
a device located proximate to an autonomous machine, including:
an interface for an entity associated with the autonomous machine, wherein the entity comprises a party interested in a potential risk relationship in connection with the autonomous machine, and
a transmitter to transmit a request signal, generated via the interface, via a distributed communication network; and
a transceiver, remote from the autonomous machine, that receives the transmitted request signal and stores the signal in a memory unit, the transceiver including a back-end application computer server to:
(i) associate the request signal with a specific future operation of the autonomous machine,
(ii) forward information about the specific future operation of the autonomous machine to a remote risk relationship platform,
(iii) receive, from the remote risk relationship platform, information about a potential risk relationship with another enterprise,
(iv) transmit at least one risk relationship offer, including information about the potential risk relationship with the other enterprise, to the device located proximate to the autonomous machine, and
(v) responsive to an agreement signal received from the device located proximate to the autonomous machine, update the risk relationship data store.

2. The system of claim 1, wherein the autonomous machine is a self-driving vehicle, the entity comprises a passenger of the self-driving vehicle, and the specific future operation of the self-driving vehicle is trip information including an origin location and a destination location.

3. The system of claim 2, wherein the enterprise is an insurer, the risk relationship is a trip-based automobile insurance policy, and the resource amount comprises an insurance premium of the trip-based automobile insurance policy.

4. The system of claim 3, wherein the trip information forwarded to the remote risk relationship platform is associated with at least one of: (i) a time of day, (ii) a location, (iii) a type of road, (iv) weather information, (v) an amount of traffic, (vi) a distance to another vehicle, (vii) operation of other machines in similar conditions, (viii) a risk hotspot, and (ix) a distance to an intersection.

5. The system of claim 3, wherein the trip information forwarded to the remote risk relationship platform is associated with at least one of: (i) anti-lock brakes, (ii) adaptive headlights, (iii) a camera, and (iv) a parking feature.

6. The system of claim 3, wherein the trip information forwarded to the remote risk relationship platform is associated with at least one of: (i) a vehicle class, (ii) a trip type, (iii) a vehicle make, model, and year of production, (iv) a passenger profile, (v) third-party information, (vi) motor vehicle registration information, (vii) prior safety scoring, and (viii) a predictive algorithm.

7. The system of claim 3, wherein the device located proximate to the self-driving vehicle comprises at least one of: (i) a smartphone, (ii) a tablet computer, (iii) a smartwatch, and (iv) a device installed in the vehicle.

8. The system of claim 3, wherein the back-end application computer server is further to communicate with at least one of: (i) a claims engine, (ii) a reporting engine, (iii) a rating engine, and (iv) a digital negotiation engine.

9. The system of claim 3, wherein the automobile insurance policy comprises at least one of: (i) a potential automobile insurance policy, (ii) a newly issued automobile insurance policy, and (iii) an automobile insurance policy renewal.

10. The system of claim 3, wherein the risk relationship offer is associated with a plurality of insurers and a plurality of trip-based automobile insurance policies.

11. The system of claim 3, wherein the agreement signal received from the device located proximate to the self-driving vehicle is automatically generated based on a passenger preference.

12. The system of claim 11, wherein the passenger preference is associated with at least one of: (i) an insurance premium, (ii) a preferred insurer, and (iii) an amount of coverage.

13. A computerized method to facilitate risk relationships for autonomous machines, comprising:
receiving, by a transceiver remote from an autonomous machine, a request signal transmitted by a device located proximate to an autonomous machine and storing the signal in a memory unit, the transceiver including a back-end application computer server, wherein the device located proximate to an autonomous machine includes: (1) an interface for an entity associated with the autonomous machine, the entity comprising a party interested in a potential risk relationship in connection with the autonomous machine, and (2) a transmitter to transmit the request signal, generated via the interface, via a distributed communication network;
associating, by a computer processor of the back-end application computer server, the request signal with a specific future operation of the autonomous machine;
forwarding information about the specific future operation of the autonomous machine to a remote risk relationship platform;
receiving, from the remote risk relationship platform, information about a potential risk relationship with another enterprise;
transmitting at least one risk relationship offer, including information about the potential risk relationship with the other enterprise, to the device located proximate to the autonomous machine; and
responsive to an agreement signal received from the device located proximate to the autonomous machine, updating a risk relationship data store, wherein the risk relationship data store contains electronic records that represent, for each of a plurality of risk relationships with an enterprise: a risk relationship identifier, an autonomous machine identifier, at least one attribute value, and a resource amount.

14. The method of claim 13, wherein the autonomous machine is a self-driving vehicle, the entity comprises a passenger of the self-driving vehicle, and the specific future operation of the self-driving vehicle is trip information including an origin location and a destination location.

15. The method of claim 14, wherein the enterprise is an insurer, the risk relationship is a trip-based automobile insurance policy, and the resource amount comprises an insurance premium of the trip-based automobile insurance policy.

16. The method of claim 15, wherein the trip information forwarded to the remote risk relationship platform is associated with at least one of: (i) a time of day, (ii) a location, (iii) a type of road, (iv) weather information, (v) an amount of traffic, (vi) a distance to another vehicle, (vii) operation of other machines in similar conditions, (viii) a risk hotspot, and (ix) a distance to an intersection.

17. The method of claim 15, wherein the trip information forwarded to the remote risk relationship platform is associated with at least one of: (i) anti-lock brakes, (ii) adaptive headlights, (iii) a camera, and (iv) a parking feature.

18. The method of claim 15, wherein the trip information forwarded to the remote risk relationship platform is associated with at least one of: (i) a vehicle class, (ii) a trip type, (iii) a vehicle make, model, and year of production, (iv) a passenger profile, (v) third-party information, (vi) motor vehicle registration information, (vii) prior safety scoring, and (viii) a predictive algorithm.

19. A non-transitory, computer-readable medium storing instructions, that, when executed by a processor, cause the processor to perform a method to facilitate risk relationships for autonomous machines, the method comprising:
receiving, by a transceiver remote from an autonomous machine, a request signal transmitted by a device located proximate to an autonomous machine and storing the signal in a memory unit, the transceiver including a back-end application computer server, wherein the device located proximate to an autonomous machine includes: (1) an interface for an entity associated with the autonomous machine, the entity comprising a party interested in a potential risk relationship in connection with the autonomous machine, and (2) a transmitter to transmit the request signal, generated via the interface, via a distributed communication network;
associating, by a computer processor of the back-end application computer server, the request signal with a specific future operation of the autonomous machine;
forwarding information about the specific future operation of the autonomous machine to a remote risk relationship platform;
receiving, from the remote risk relationship platform, information about a potential risk relationship with another enterprise;
transmitting at least one risk relationship offer, including information about the potential risk relationship with the other enterprise, to the device located proximate to the autonomous machine; and
responsive to an agreement signal received from the device located proximate to the autonomous machine, updating a risk relationship data store, wherein the risk relationship data store contains electronic records that represent, for each of a plurality of risk relationships with an enterprise: a risk relationship identifier, an autonomous machine identifier, at least one attribute value, and a resource amount.

20. The medium of claim 19, wherein the autonomous machine is a self-driving vehicle, the entity comprises a passenger of the self-driving vehicle, and the specific future operation of the self-driving vehicle is trip information including an origin location and a destination location.

21. The medium of claim 20, wherein the enterprise is an insurer, the risk relationship is a trip-based automobile insurance policy, and the resource amount comprises an insurance premium of the trip-based automobile insurance policy.

22. The medium of claim 21, wherein the device located proximate to the self-driving vehicle comprises at least one of: (i) a smartphone, (ii) a tablet computer, (iii) a smartwatch, and (iv) a device installed in the vehicle.

23. The medium of claim 21, wherein the risk relationship offer is associated with a plurality of insurers and a plurality of trip-based automobile insurance policies.

24. The medium of claim 21, wherein the agreement signal received from the device located proximate to the self-driving vehicle is automatically generated based on a passenger preference.

25. The medium of claim 24, wherein the passenger preference is associated with at least one of: (i) an insurance premium, (ii) a preferred insurer, and (iii) an amount of coverage.
